(19) United States
(12) Patent Application Publication
(10) Pub. No.: US 2016/0033268 A1
(43) Pub. Date: Feb. 4, 2016

(54) APPARATUS FOR AUGMENTED REALITY FOR OPTICAL SYSTEMS

(71) Applicants: Michael Franklin Abernathy, Albuquerque, NM (US); David Paul Geisler, Mount Horeb, WI (US)

(72) Inventors: Michael Franklin Abernathy, Albuquerque, NM (US); David Paul Geisler, Mount Horeb, WI (US)

(21) Appl. No.: 14/448,476

(22) Filed: Jul. 31, 2014

(51) Int. Cl. G01C 3/08

(52) U.S. Cl. CPC G01C 3/08

(57) ABSTRACT

Accurate estimates of object location are established from an optical platform. Platform position is combined with dynamic data including target distance and target line of sight data to calculate target location. These target locations can be saved and shared with other users in real-time. Users may find these target locations based upon augmented reality cues provided by the system.

### FIELD OF THE INVENTION

Embodiments relate to the fields of optical systems as used for hunting, wildlife watching, wildlife research and management. In particular, embodiments relate to the finding, sharing, and re-locating points of interest.

### BACKGROUND

People enjoy a variety of activities such as bird watching, hunting, geo-caching. It is common that a person observes a distant object and then attempts to get closer to it. Unless the person is skilled, it is also common that a person loses the location of that distant object. For example, a bird watcher could glimpse a distant woodpecker but be too far to properly identify it. The bird watcher may have to cross difficult terrain, pass through woods, or do something else such that they lose sight of the woodpecker and may even slightly lose their own bearings. The bird watcher may never record their sighting of a rare woodpecker because they lost the bird's location.

A skilled bird watcher can use a variety of techniques to relocate their sighting. For instance, they can carefully note distinctive terrain features near the bird, behind the bird, near themselves, and behind themselves. They can position a bright ribbon at their current location for later reference. The skilled bird watcher can often relocate their sighting by reorienting themselves with respect to the distinctive features. Reorientation is a skill and is always uncertain. Systems and methods supporting a person's efforts to relocate a sighting or other location of interest are needed.

### SUMMARY

Aspects of the embodiments address limitations and flaws in the prior art by using a position and angular measurement device to cue the viewer to relocate the sighting or similar location of interest. Certain embodiments may also include cues sent via smart-phone messages and photos that contain location data.

It is therefore an aspect of the embodiments that a user can operate a targeting module to observe an object. The targeting module can receive electromagnetic radiation, such as light, reflected from the object and use that reflected light to provide an image to the observer. Items that present reflect light images include binoculars, sighting tubes, rifle scopes, and video cameras.

It is another aspect of the embodiments that a target vector extends from the targeting module to the object being observed. A vector has both length and direction.

It is a further aspect of the embodiments that position location data, the location of the targeting module, is determined by a positioning module such as a GPS or similar satellite navigation data receiver, radio frequency position sensor, or accelerometer/gyroscope based position tracker. The position location data can specify a horizontal location using a pair of numbers such as latitude and longitude. In certain embodiments, the position location data can specify an elevation such as the elevation above sea level or the elevation above some other reference. The elevation can be determined by devices similar to or the same as those that determine horizontal location or by altitude specific devices such as altimeters that compare a local air pressure to the air pressure measured at a nearby point having a known elevation.

It is yet a further aspect of the embodiments that a distance measuring module such as a laser range finder determines the length of the target vector.

It is yet another aspect of the embodiments that an azimuth module determines an azimuth between the target vector and a reference vector such as true north or magnetic north. An elevation angle module, perhaps including an inclinometer, can measure an elevation angle to thereby provide for determining the location of the object in three dimensions.

It is still yet another aspect of the embodiments that a target location, specified by target location data, is determined based on targeting data such as the targeting module's location, the target vector length, the azimuth, and perhaps the elevation angle. The target location is the calculated location of the object being targeted and may differ from the objects actual location if there are errors in the targeting data.

It is still yet a further aspect of the embodiments that the user is presented with an indication of the target location. The target location can be presented as an absolute position where, for example, a display shows the target location in the center, shows the user's position relative to the target location, and where the user's position on the display changes as the user moves. The target position can instead be shown relative to the user. For example, the user's position can be centered on a display while the target location is shown relative to the user's position. The azimuth module can provide information indicating the direction the embodiment is currently facing to thereby align the display with true north, magnetic north, or the current facing, or some other direction. Another example is that the display presents an arrow, perhaps only the arrow, pointing toward the target location and, in some embodiments, the distance to the target location. In these examples the target location is stored or otherwise retained in some non-transitory medium such that the relative position between user and target can be updated without requiring further sighting or targeting of the object.

A sensor suit comprising the positioning module, azimuth module, distance measuring module, and perhaps an elevation module can be carried by the user. For example, enhanced binoculars, spotting scopes, and rifle scopes can include or link to such a sensor suite or individual modules. It is not necessary for the user to remain with or carry the targeting module though. A person only needs a location module and a display in order to approach a known target location. In fact, a first person can determine the target location and transmit that location to a second person.

Alternatively, a communications module can provide the capability for a remotely operated sensor suite to be remotely commanded to determine a target location for transmittal to the controlling person or someone else entirely. For example, an Internet enable sensor suite can be used to monitor a marsh and to provide date for guiding bird watchers to the location of a rare loon.

Further aspects of embodiments having a communications module include a remote analysis system that determines and perhaps stores target locations, positioning location data, or both. A moving user can generate a user path that includes positioning location data that is updated and time stamped as the user moves. A moving target can generate a target path that includes numerous target waypoints produced from numerous time stamped observations of a specific target. The remote analysis system can provide target location data or target waypoints to the user and to additional users. The additional users can then attempt to locate the target, perhaps even generating further observations and waypoints that are uploaded to the remote analysis system and shared with the other users. A remote data server can share target locations, position location data, target waypoints, and user waypoints without also performing analysis to also determine those waypointed locations as the waypoints or locations themselves are uploaded to the remote data server. Labels such as “Mike,” “Richard,” or “Great Blue Heron” can be associated with locations to thereby become named locations or waypoints. Labels can also be associated with paths (or routes). The labels can be presented to the user(s) along with the locations or paths.

An aspect of some embodiments is that the presentation comprises a map graphic such that the user can see the target location or targeting module location on a map, perhaps even a topographic map. Some embodiments can use line-of-sight type calculations and map data, such as a topological map, to determine hiding places or hide regions that cannot be seen from the target location. The presentation can show the hide regions and the user can navigate to or though hide regions to avoid being seen.

### BRIEF DESCRIPTION OF THE FIGURES

The accompanying figures, in which like reference numerals refer to identical or functionally similar elements throughout the separate views and which are incorporated in and form a part of the specification, further illustrate the present invention and, together with the background of the invention, brief summary of the invention, and detailed description of the invention, serve to explain the principles of the present invention.

FIG. 1 illustrates a person tagging an animal's location in accordance with aspects of the embodiments;

FIG. 2 illustrates a system that tags distant locations in accordance with aspects of the embodiments;

FIG. 3 illustrates a high level block diagram of a system that tags distant locations in accordance with aspects of the embodiments; and

FIG. 4 illustrates a high level block diagram of a system that shares tags of distant locations in accordance with aspects of the embodiments.

### DETAILED DESCRIPTION

The particular values and configurations discussed in these non-limiting examples can be varied and are cited merely to illustrate embodiments and are not intended to limit the scope of the invention

Users of binoculars, monoculars, telescopic rifle sights, spotting scopes, sighting tubes, and similar surveillance systems can benefit from the ability to locate specific places in three-dimensional space. For example, a hunter may spot a game animal out of shooting range, but visible to the scope and laser range finder. The subject invention will allow the hunter to record that geographic location. The hunter may then change locations for a better shooting angle, and the subject invention will display augmented reality cues assisting in finding the line of sight to the point of interest—in this case game animal.

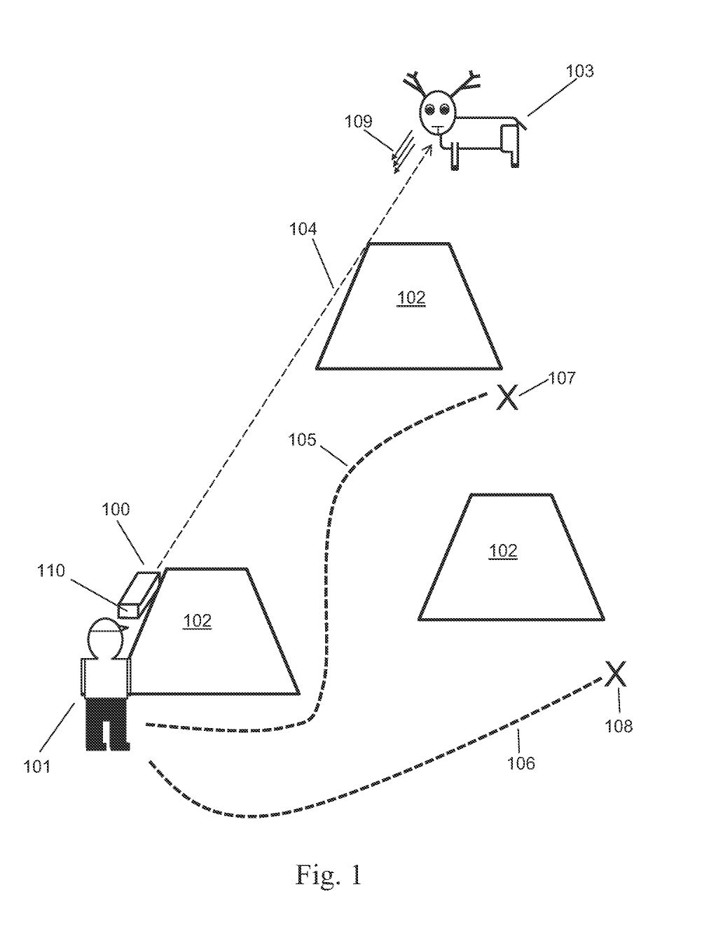

FIG. 1 illustrates a person 101 tagging an animal's location in accordance with aspects of the embodiments. The person 101 looks into the optic or display 110 of a targeting module 100 to view an animal 103. The targeting module 100 receives electromagnetic radiation 109, such as visible light or infrared light and provides an image of the animal 103 to the person 101. A target vector 104 having both length and direction extends from the person 101 to the animal 103.

The person 101 of FIG. 1 is mostly hiding in a hide region behind an obstruction 102 such that the animal 103 is less likely to observe the person 101. Other hide regions 107, 108 exist behind other obstructions 102. The user can reach hide regions 107, 108 by following paths 105, 106, respectively.

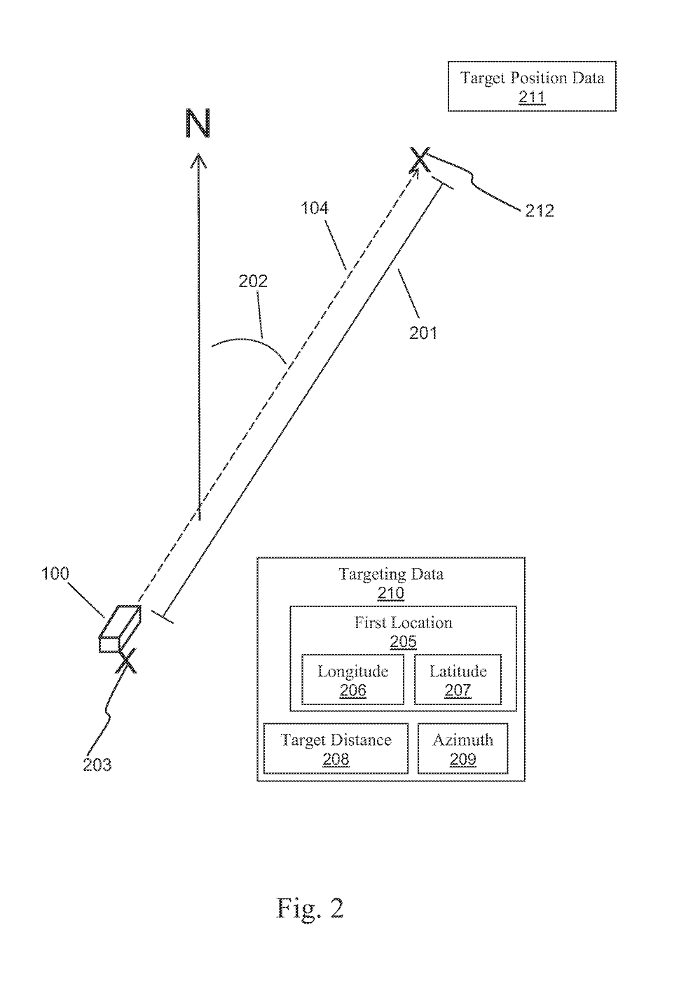

FIG. 2 illustrates a system that tags distant locations in accordance with aspects of the embodiments. The targeting module 100 is located at a first position 203. The targeting vector 104 has an azimuth 202 relative to true north or magnetic north (actually both as they have a constant offset from any given position on earth.) The target vector also has a distance or length 201 which is the distance between the first position 203 and the target position 212. The targeting data 210 includes a first location 205, a target distance 208, and an azimuth 209. The first location 205 can be a horizontal location specified by its longitude 206 and latitude 207. The first location 205 is data specifying the first position. The azimuth 208 in the targeting data 210 records azimuth 202 of the targeting vector. The target distance. 208 in the targeting data records the length 201 of the targeting vector. Simple trigonometric analysis of the targeting data 210 yields the target position data 211 that specifies an estimate of the target position 212.

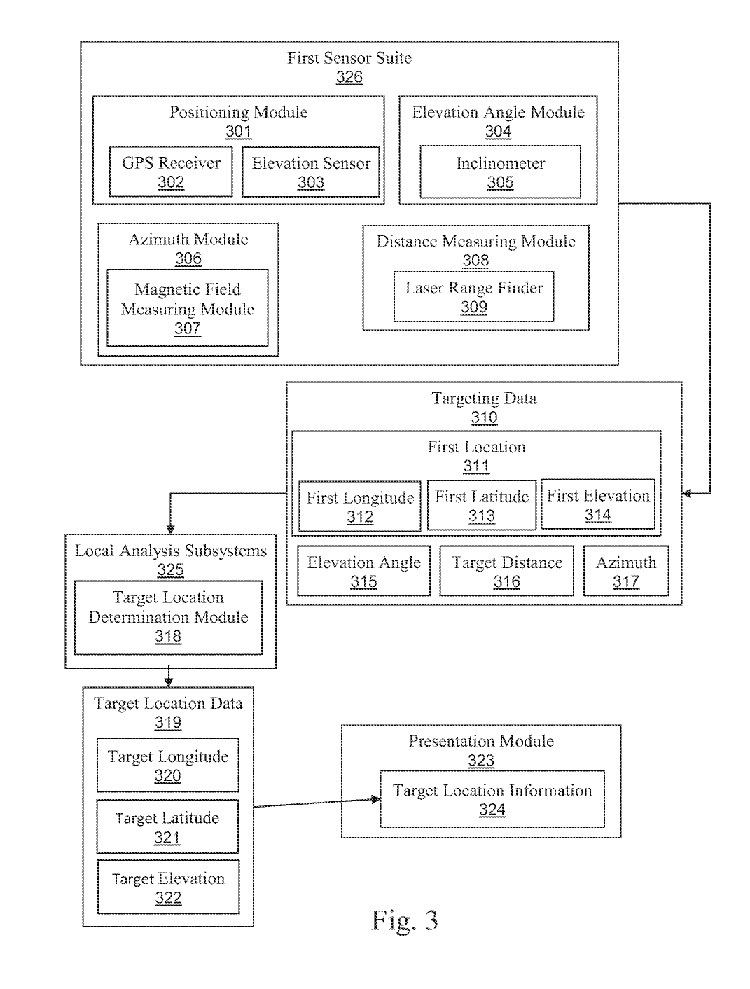

FIG. 3 illustrates a high level block diagram of a system that tags distant locations in accordance with aspects of the embodiments. A targeting module can operate in conjunction with a sensor suite to produce targeting data. Packaging the sensor suite with the targeting module, such as with an instrumented binocular, provides a convenient and handy package for pinpointing target locations. A different convenient package is a smart phone with the user pointing the phone's camera at the target, but only with a distance measuring device or capability attached to or incorporated in the smart phone. Many modern smart phones include sensors that detect heading or facing, level or inclination, position, and elevation.

A first sensor suite 326 includes a positioning module 301, azimuth module 306, distance measuring module 308, and optionally an elevation angle module 304. The positioning module 301 provides the first location 205 and can include a GPS receiver 302 or similar device for determining a geographic location. The positioning module 301 can also include an elevation sensor 303 such as an altimeter or the GPS receiver. The azimuth module 306 provides the azimuth 209 and can include a magnetic field sensor or measuring module. The azimuth 209 is the measured direction of the target vector 104. Azimuth has also been measured with gyroscopic devices that have been calibrated to a reference vector, often true north. The distance measuring module 308 provides the target distance 208 and can include a laser range finder 309 or other distance measuring device. The elevation angle module 304 determines the elevation angle of the targeting vector and can include an inclinometer 305 or other device for measuring angles relative to the horizontal plane or direction vector of the earth's gravity.

The sensor suite 326 is illustrated as including an elevation angle module 304 and an elevation sensor 303 so that it is useful for determining location in three dimensions. If horizontal or two dimensional determinations are sufficient for a purpose or device, then elevation and elevation angle need not be measured.

The sensor suite 326 can produce targeting data 310 specifying the first location 311, elevation angle 315, target distance 316, and azimuth 317. The first location 311 can specify a location in three dimensions by using, for example, a first longitude 312, first latitude 313, and first elevation 314. The targeting data 310 can be passed to local or remote analysis systems that can use trigonometric calculations to determine the location of a target. Local analysis subsystems 325 having a target location determination module 318 accepts targeting data 310 and produces target location data 319. Target location data 319 can include target longitude 320, target latitude 321, and target elevation 322 specify the targets location in three dimensions. A presentation module 323 can display target location information 324 to a person. The target location information can be an arrow pointing from the person location to the target, perhaps with the distance also displayed. The target information can be points, flags, icons or pins. The display can present the target information over a map. In general, the target information can be presented textually, graphically, or both such that the user can relocate the target.

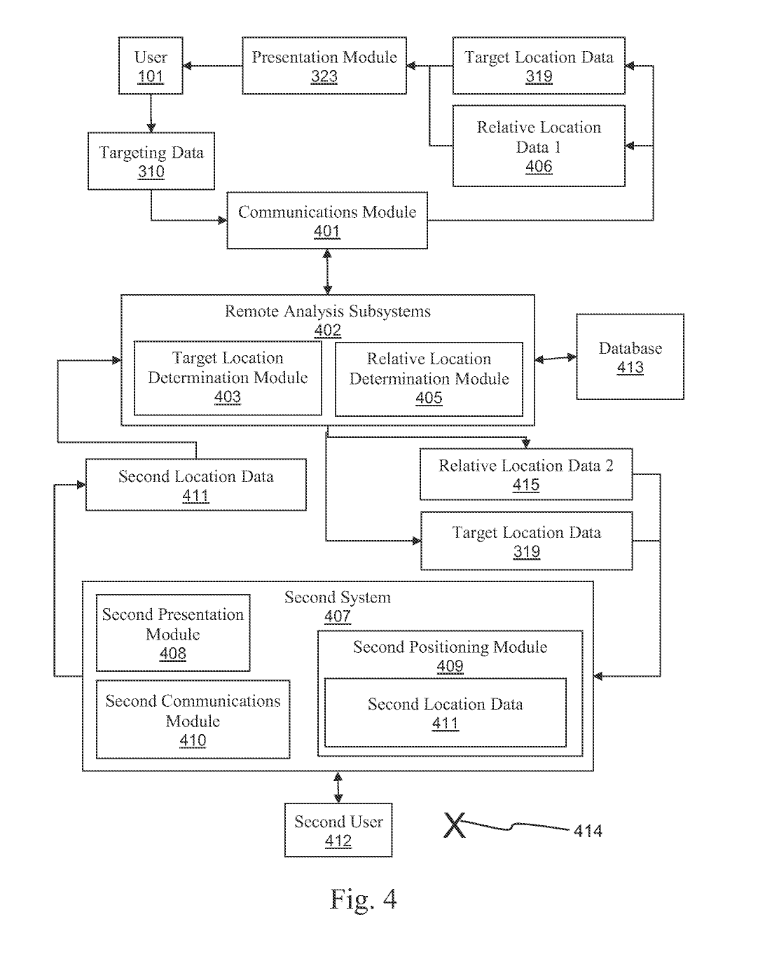

FIG. 4 illustrates a high level block diagram of a system that shares tags of distant locations in accordance with aspects of the embodiments. In the embodiment of FIG. 4, a user 101 uses a targeting module to generate targeting data 310. Instead of being locally analyzed, the targeting data can instead be passed to a communications module 401 and then to a remote analysis subsystem 402. The remote analysis system can then calculate target location data 319 that is then returned to the communications module 401 and displayed to the user 101 by a presentation module 323. The remote analysis system can also calculate relative location data 1 406 to be returned and displayed to the user 101. Target location data can specify a geographic coordinate which is an absolute coordinate relative to a globally recognized reference point. Relative location data is not absolute but is instead relative to something else such as the user's 101 current location and perhaps even the user's current heading. For example, relative location data could specify that the target is 45 meters directly ahead.

A second user 412 can also acquire the target by using a second system 407 to send second location data 411 specifying a second location 414 to the remote analysis system 402. The second system 407 can include a second positioning module 409 for determining the second location data 411, a second presentation module 408 for presenting information to the second user 412, and a second communications module 410 for communicating with the remote analysis subsystem 402.

The remote analysis subsystem 402 can send relative location data 2 415 or target location data 319 to the second system for presentation to the second user 412. The remote analysis subsystem 402 can calculate relative location data 2 415 based on second location data 411 and return it to the second system 407. The remote analysis system 402 can also return target location data 319. If relative locations are not needed or desired, then the remote analysis system can simply obtain target location data 319, which has been previously stored in database 413, and provide it to the second system 407. Database 413 can store targeting data 310, the location of the first user which is included in the targeting data 310, and the second location data 411, and other data. The data can be stored repeatedly as users and targets move to thereby store paths. The data can be time stamped to provide a more historical record. The different targets and users can be identified by labels or tags such as “Mike,” “Richard,” “Grebe Nest,” or “Bison.”

The remote analysis subsystem 402 and database 413 are illustrated as separate from the devices carried by the users 101, 412 because some embodiments can be cloud based with many system components instantiated on distant servers. In other embodiments, the analysis, data storage, and database functions can be performed by the user's devices with those devices communicating with each other.

The embodiment and examples set forth herein are presented to best explain the present invention and its practical application and to thereby enable those skilled in the art to make and utilize the invention. Those skilled in the art, however, will recognize that the foregoing description and examples have been presented for the purpose of illustration and example only. Other variations and modifications of the present invention will be apparent to those skilled in the art following the reading of this disclosure, and it is the intent of the appended claims that such variations and modifications be covered.

The description as set forth is not intended to be exhaustive or to limit the scope of the invention. Many modifications and variations are possible in light of the above teaching without departing from the scope of the following claims. It is contemplated that the use of the present invention can involve components having different characteristics. It is intended that the scope of the present invention be defined by the claims appended hereto, giving full cognizance to equivalents in all respects.

What is claimed is:

1. A system comprising:
a targeting module that a user operates to observe and to specify a target wherein the targeting module receives electromagnetic radiation reflected from the target and wherein a target vector extends from the targeting module to the target;
a positioning module that determines a first location wherein the first location is a geographic location of the targeting module and wherein the first location specifies a targeting module horizontal location;
a distance measuring module that determines a target distance wherein the target distance is the target vector's length;
an azimuth module that determines an azimuth between the target vector and a reference vector;
wherein a target location data is determined from targeting data comprising the first location, target distance, and the azimuth, wherein the target location data comprises a target horizontal location, and wherein the target location data specifies a target location; and
a presentation that presents target location information indicating the target location to the user.

2. The system of claim 1 wherein the electromagnetic radiation is light.

3. The system of claim 1 wherein the distance measuring module comprises a laser range finder.

4. The system of claim 1 wherein the positioning module comprises a GPS receiver.

5. The system of claim 1 further comprising an elevation angle module that determines an elevation angle of the targeting vector, wherein the first location further specifies a targeting module elevation, wherein the targeting data further comprises the targeting module elevation and the elevation angle, and wherein the target location data comprises a target elevation.

6. The system of claim 1 wherein the target location data is retained and wherein the presentation presents the target location information indicating the target location relative to the user after the user moves to a different location wherein the user carries the targeting module.

7. The system of claim 1 further comprising a communications module wherein the targeting data is passed to an analysis system that determines the target location.

8. The system of claim 1 wherein the target location is communicated to a second system having a second position and wherein the second system provides a second presentation that indicates the target location to a second user.

9. The system of claim 8 wherein the second system comprises a second positioning module that determines a second location that is a geographic location of the second system and wherein the second presentation indicates the target location relative to the second user.

10. A system comprising:
a targeting module that a user operates to observe and to specify a target wherein the targeting module receives electromagnetic radiation reflected from the target and wherein a target vector extends from the targeting module to the target;
a positioning module that determines a first location wherein the first location is a geographic location of the targeting module and wherein the first location specifies a targeting module horizontal location;
a distance measuring module that determines a target distance wherein the target distance is the target vector's length;
an azimuth module that determines an azimuth between the target vector and a reference vector;
wherein a target location data is determined from targeting data comprising the first location and the azimuth, wherein the target location data comprises a target horizontal location, and wherein the target location data specifies a target location; and
a presentation that presents target location information to the user by indicating the target location on a map graphic.

11. The system of claim 10 further comprising a target waypoint wherein the target waypoint comprises the target location data and a target label and wherein the target waypoint is stored in a non-transitory memory device.

12. The system of claim 11 wherein the target waypoint further comprises a time stamp wherein the time stamp specifies when the targeting data was obtained.

13. The system of claim 10 further comprising a target route wherein the user operates the targeting module a plurality of times on the same target such that a plurality of waypoints is produced with each of the waypoints comprising target location data and a timestamp to thereby indicate the time at which the target was at a particular location, and wherein the target route comprises a target label and the plurality of target waypoints.

14. The system of claim 10 wherein the map graphic is a topological map graphic.

15. The system of claim 14 wherein the presentation further presents at least one hide region to indicate geographic regions having an obstructed line of sight to the target.

16. A system comprising:
a targeting module that a user operates to observe and to specify a target wherein the targeting module receives electromagnetic radiation reflected from the target, wherein the electromagnetic radiation is light, and wherein a target vector extends from the targeting module to the target;
a positioning module comprising a GPS receiver that determines a first location wherein the first location is a geographic location of the targeting module, and wherein the first location comprises a targeting module horizontal location and a targeting module elevation;
a distance measuring module comprising a laser range finder that determines a target distance wherein the target distance is the target vector's length;
an azimuth module that determines an azimuth between the target vector and a reference vector;
an elevation angle module that determines an elevation angle of the targeting vector;
wherein a target location data is determined from targeting data wherein the targeting data comprises the first location, the azimuth, and the elevation angle, wherein the target location data comprises a target horizontal location and target elevation, and wherein the target location data specifies a target location;
a presentation that presents target location information to the user by indicating the target location on a map graphic;
wherein the target location data is retained for further use and wherein the presentation presents the target location information indicating the target location relative to the user after the user moves to a different location wherein the user carries the targeting module;
a communications module wherein the targeting data is passed to an analysis system that determines the target location;
wherein the target location is communicated to a second system having a second position and wherein the second system provides a second presentation that indicates the target location to a second user; and
wherein the second system comprises a second positioning module that determines a second location that is a geographic location of the second system and wherein the second presentation indicates the target location relative to the second user.

17. The system of claim 16 further comprising a target waypoint wherein the target waypoint comprises the target location data and a target label and wherein the target waypoint is stored in a non-transitory memory device.

18. The system of claim 17 wherein the target waypoint further comprises a time stamp wherein the time stamp specifies when the targeting data was obtained.

19. The system of claim 18 further comprising a target route wherein the user operates the targeting module a plurality of times on the same target such that a plurality of waypoints is produced with each of the waypoints comprising target location data and a timestamp to thereby indicate the time at which the target was at a particular location, and wherein the target route comprises a target label and the plurality of target waypoints.

20. The system of claim 19 wherein the map graphic is a topological map graphic and wherein the presentation further presents at least one hide region to indicate geographic regions having an obstructed line of sight to the target.
